(19) United States
(12) Patent Application Publication
(10) Pub. No.: US 2025/0016041 A1
(43) Pub. Date: Jan. 9, 2025

(54) SERVICE PROVISIONING AND CONFIGURATION FOR ACCESSING PALS HOSTING NETWORK

(71) Applicant: InterDigital Patent Holdings, Inc., Wilmington, DE (US)

(72) Inventors: Guanzhou Wang, Brossard (CA); Zhibi Wang, Woodridge, IL (US); Anuj Sethi, Ottawa (CA); Tezcan Cogalan, London (GB); Saad Ahmad, Montreal (CA)

(73) Assignee: InterDigital Patent Holdings, Inc., Wilmington, DE (US)

(21) Appl. No.: 18/706,959

(22) PCT Filed: Nov. 4, 2022
(86) PCT No.: PCT/US2022/049043

§ 371 Date: May 2, 2024

Related U.S. Application Data
(63) Continuation of application No. 63/411,966, filed on Sep. 30, 2022.
(60) Provisional application No. 63/276,132, filed on Nov. 5, 2021.
(60) Provisional application No. 63/303,468, filed on Jan. 26, 2022.

(51) Int. Cl. H04L 41/0659; H04L 41/0816; H04W 24/04

(52) U.S. Cl. CPC H04L 41/0661; H04L 41/0816; H04W 24/04

(57) ABSTRACT

Systems, methods, and instrumentalities are disclosed for service provisioning and providing access to a PALS hosting network. In examples, a WTRU may send a first message to a first network node if a configuration failure event is detected, wherein the first network node is associated with a first network, wherein the configuration failure event is associated with a second network, and wherein the first message indicates an update request for a network configuration for a local service. The WTRU may receive a second message from the first network node, wherein the second message indicates a response to the update request, indicates an updated network configuration, and indicates a slice identifier associated with the second network The WTRU may receive a third message from the first network node, wherein the third message indicates policy information associated with the local service. The WTRU may send a fourth message to a second network node, wherein the second network node is associated with the second network, wherein the fourth message is based on the policy information and the updated network configuration, and wherein the fourth message indicates a registration request associated with the slice identifier.

### CROSS REFERENCE TO RELATED APPLICATIONS

This application claims the benefit of U.S. Provisional Patent Application No. 63/276,132, filed Nov. 5, 2021, and Provisional Patent Application No. 63/303,468, filed Jan. 26, 2022, and Provisional Patent Application No. 63/411,966, filed Sep. 30, 2022, the contents of which are hereby incorporated by reference herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are disclosed for service provisioning and providing access to a PALS hosting network. A configuration failure event may be detected. A first message may be sent to a first network node based on the detected configuration failure event. The first network node may be associated with a first network. The configuration failure event may be associated with a second network. The first message may indicate an update request for a network configuration for a local service. A second message may be received from the first network node. The second message may indicate a response to the update request. The second message may indicate an updated network configuration. The second message may indicate one or more slice identifiers associated with the second network. A third message may be received from the first network node. The third message may indicate policy information associated with the local service. A fourth message may be sent to a second network node. The second network node may be associated with the second network. The fourth message may be based on the policy information and the updated network configuration. The fourth message may indicate a registration request associated with one or more slice identifiers.

Systems, methods, and instrumentalities are disclosed for service provisioning and providing access to a PALS hosting network. A first message may be received from a wireless transmit/receive unit (WTRU). The first message may comprise a registration message. The registration message may indicate that the WTRU has detected a configuration failure event associated with a second network. The registration message may indicate an update request for a network configuration for a local service. The configuration information may be determined. The configuration information may be associated with the WTRU obtaining access to the second network. A second message may be sent to the WTRU. The second message may indicate at least one of a registration acceptance message or a configuration update message responsive to the update request. An updated control policy for the WTRU may be determined using the determined configuration information. A third message may be sent to the WTRU. The third message may comprise the updated control policy.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows an example of a hosting network having access (e.g., direct access) to a home network.

FIG. 3 shows an example of a hosting network having access (e.g., indirect access) to a home network.

FIG. 4 shows an example of providing access to localized services (PALS) configuration via a home network.

FIG. 5 shows an example hosting network pushing PALS service information to a home network of a WTRU.

FIG. 6 shows an example of PALS service information retrieval from a home network.

FIG. 7 shows an example of a WTRU receiving local policies from the hosting network.

FIG. 8A shows an example of providing access (e.g., direct access) to a network, such as a mobile network (PLMN) network.

FIG. 8B shows an example of providing access (e.g., indirect access) to a network, such as a PLM network.

FIG. 9 shows an example of configuring the roaming WTRU with the PALS service.

FIG. 10 shows an example of provisioning the roaming WTRU with PALS access ID and credentials.

### DETAILED DESCRIPTION

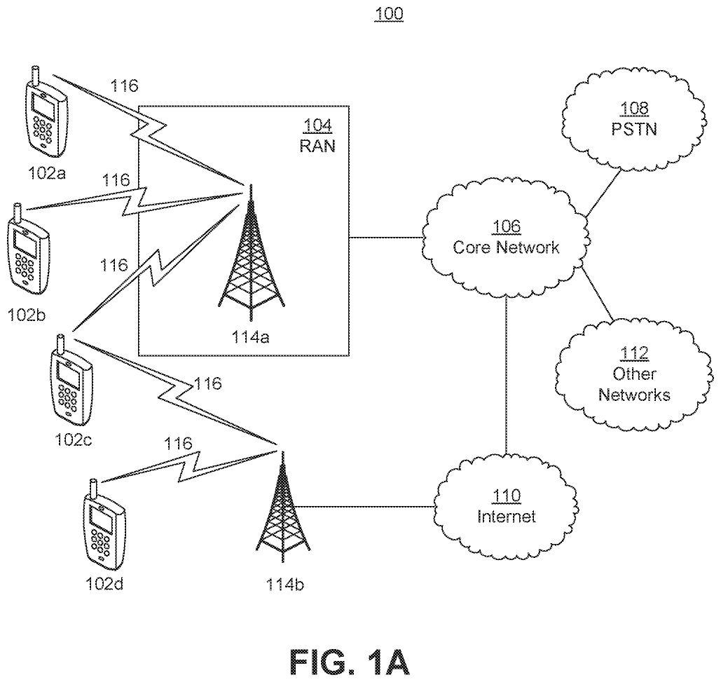

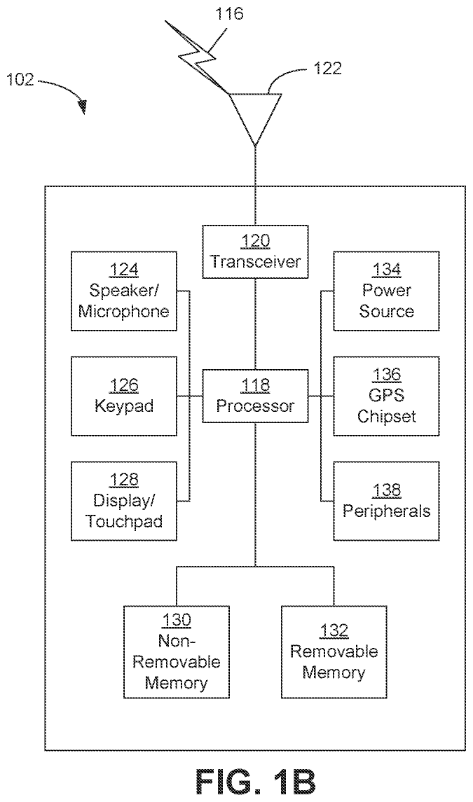

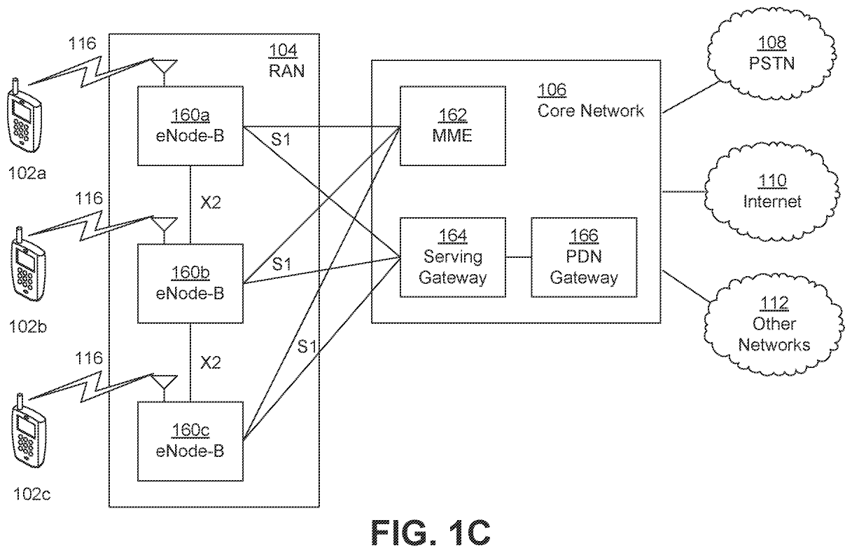

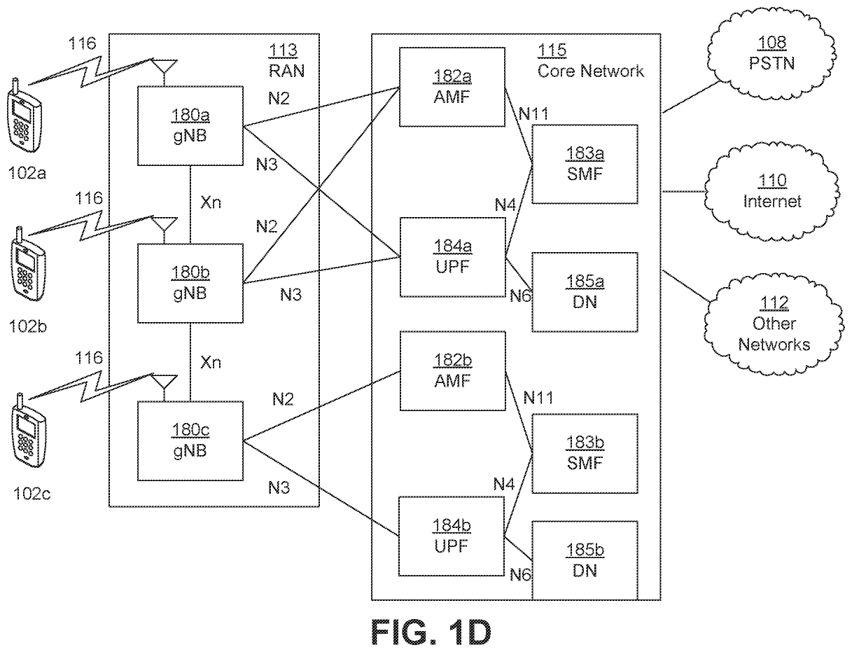

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WIFI), IEEE 802.16 (i.e., Worldwide Interoperability for Microwave Access (WiMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (Qos) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology.

The CN 106/115 may also serve as a gateway for the WTRUs 102a, 102b, 1020, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 1020, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHZ channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Networks Providing Access to Localized Services (PALS network) may be provided. In examples, a cellular network (e.g., a small cellular network) may be deployed to provide services to one or more local users within an area. For example, a temporary non-public cellular network may be set up to provide streaming video service to an audience, e.g., in a live concert or a football match. In places like an airport, a shopping mall, or a school campus, e.g., where a large crowd may gather, small cellular networks may be deployed to provide localized services, such as commercial ads in the shopping mall. The services provided by the small cellular networks may comprise one or more of characteristics. As an example, the services may be localized (e.g., the services are related to the activities/events in a certain spot or area and are limited to the users within the area. As an example, the users may not utilize the services on a regular basis but rather in an on-demand and/or temporary fashion.

The localized services described herein may be provided. A user may access a hosting network that provides one or more services. As used herein, a localized service may be referred to as a “PALS service” and the network that provides a PALS service may be referred to as a “PALS network,” a “PALS hosting network,” or a “hosting network.”

A PALS hosting network may be a non-public network as described herein. A PALS service user may not have subscription to a PALS network. The PALS service provider may be the PALS network operator, another mobile network operator, or a third-party service provider.

A WTRU may need a configuration to be able to access the services of a network (e.g., a public land mobile network (PLMN) or a standalone non-public network (SNPN)). In examples, a WTRU may be configured with network slicing information, such as a configured network slice selection assistance information (NSSAI), or an allowed NSSAI for a PLMN or SNPN. The network may provide a configuration indicating a NSSAI that may be used by WTRU and/or may verify a requested network slice for the WTRU, for example, if the WTRU requested network slice (e.g., requested NSSAI) may be allowed based on the WTRU's subscription information. In the case of PALS service, the hosting network may not have subscription information for its user(s) and may not have the means to configure the slicing information and/or to verify the requested network slices for the WTRUs. This may be an issue, for example, if the hosting network accommodates multiple local services, with each service utilizing its dedicated network slice at the same time.

In examples, if a WTRU requests a network resource (e.g., request a protocol data unit (PDU) session establishment), the WTRU may rely on one or more rules, such as a UE route selection policy (URSP), to associate the application(s) to a set of parameters for resource request, such as data network name (DNN) and/or single network slice selection assistance information (S-NSSAI). URSP rules may be configured by the Home PLMN or a subscribed SNPN. In the case of PALS services, the Home PLMN or SNPN may not know in advance which PALS services the WTRU may be accessing and may not be able to provide corresponding configurations in the URSP rules. Without appropriate URSP rules for the PALS service, the WTRU may have to use a default rule (e.g., the rule that matches all application traffic) which may not be applicable in the PALS hosting network.

The hosting network may not have a business agreement with the WTRU's home PLMN (HPLMN). The business agreement of the hosting network and a PLMN (e.g., a VPLMN for the WTRU) may be used for the WTRUs to get service from a hosting network. To provide the local service to the roamer, configuration information and associated credentials may be provisioned into the WTRU and its HPLMN.

To enable configurations (e.g., proper configurations) in WTRU(s) for accessing PALS services in a hosting network, one or more of the following may be provided: how to configure the slicing information in a WTRU for accessing a PALS hosting network, or how to configure the URSP rules in a WTRU for accessing a PALS hosting network.

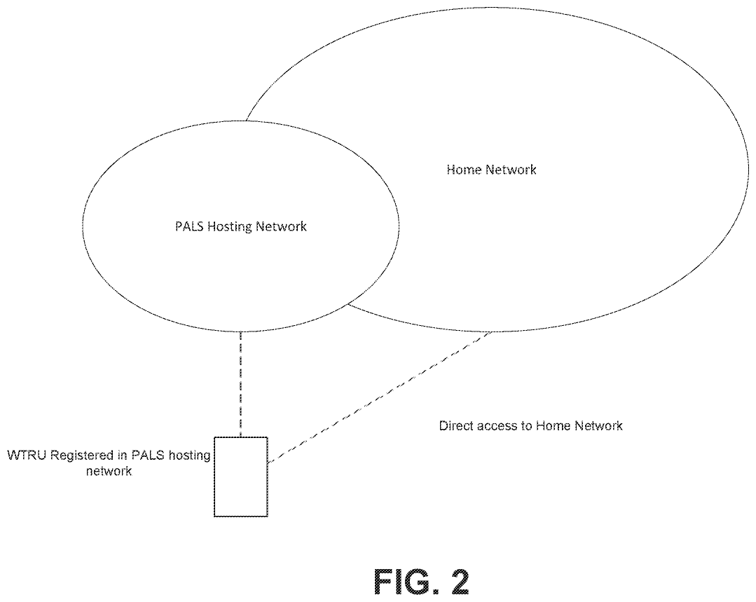

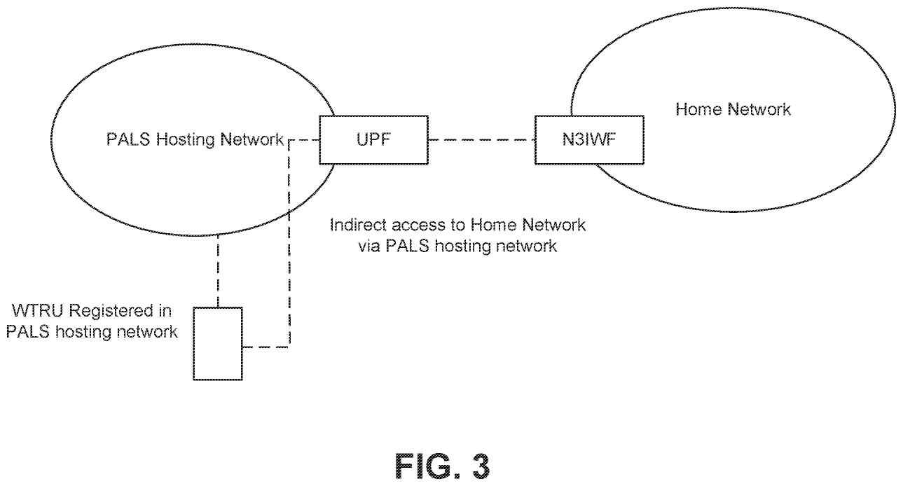

A PALS service configuration may be provided via the home network. In examples, it may be assumed that the WTRU's home network (e.g., home PLMN or subscribed SNPN) has obtained the PALS service information. The PALS service information may include the identification of the hosting network for the PALS service, the identifiers of the PALS services provided in the hosting network, the network slices deployed in the hosting network for the PALS services, the application identifier or descriptor that may be used to access PALS services, and/or the like. The home network may obtain the service information via a process with the PALS service providers. The home network may assume that a WTRU registered in the PALS hosting network may access the home network, for example, either directly if it is in the coverage of the home network (e.g., as described with respect to FIG. 2), or indirectly through the PALS hosting network and the non-3GPP interworking function (N3IWF) in the home network (e.g., as described with respect to FIG. 3).

Systems, methods, and instrumentalities are disclosed for networks providing access to localized services (PALS network). In examples, a WTRU may obtain a configuration and/or policy for PALS service/network from its home network. The WTRU may provide a PALS service and/or network information to the home network and may receive configuration and/or policy update(s) from the home network. In examples, the WTRU may obtain and store a list of temporary subscriber data for accessing a PALS hosting network. Temporary subscriber data may be associated with a PALS service, a valid location, and/or a time period.

In examples, a WTRU may receive, from a home network, configuration information associated with a network for providing access to localized services (PALS). The WTRU may send a message to the home network, the message indicating a request for updated information associated with the PALS network. The WTRU may receive update information from the home network based on the requested for updated information associated with the PALS network. The WTRU may send a registration message to the PALS network based on the updated information received from the home network. In examples, the WTRU may receive policy information for a PALS network. In examples, the WTRU may update the policy information based on the update information. If a visiting network has a business agreement with the PALS hosting network, the information may be provisioned including PALS service, network information, and/or policy for PALS service for visiting WTRU and a home network. The WTRU may receive configuration and/or policy update via the visiting network (VPLMN), for example, which may have a business agreement with the hosting network.

Systems, methods, and instrumentalities are disclosed for service provisioning and providing access to a PALS hosting network. A configuration failure event may be detected. A first message may be sent to a first network node based on the detected configuration failure event. The first network node may be associated with a first network. The configuration failure event may be associated with a second network. The first message may indicate an update request for a network configuration for a local service. A second message may be received from the first network node. The second message may indicate a response to the update request. The second message may indicate an updated network configuration. The second message may indicate one or more slice identifiers associated with the second network. A third message may be received from the first network node. The third message may indicate policy information associated with the local service. A fourth message may be sent to a second network node. The second network node may be associated with the second network. The fourth message may be based on the policy information and the updated network configuration. The fourth message may indicate a registration request associated with one or more slice identifiers.

In an example, the configuration failure event may indicate at least one of a requested slice identifier was rejected by the second network node, a configuration is missing a slice identifier, a routing rule is missing, the second network node requested a configuration update, a configuration for the local service is missing, or a configuration includes an error.

In an example, a registration failure event may be detected. The first message may be sent to the first network node based on the detected configuration failure event and the detected registration failure event. The registration failure event may indicate that the WTRU is unable to register with the second network.

In an example, a local service failure event may be detected. The first message may be sent to the first network node based on the detected configuration failure event and the local service failure event. The local service failure event may indicate that the WTRU is unable to use the local service.

In an example, the configuration failure event may be associated with the WTRU connecting to the second network node for use with the local service.

In an example, a WTRU may access the second network by communicating with the first network when the WTRU sends the first message to the first network node based on the detected configuration failure event.

In an example, the first message indicating the update request further may comprise a request for at least one of the updated network configuration, the slice identifier associated with the second network, or the policy information associated with the local service.

In an example, the first network node may comprise an access and mobility management function (AMF) of the first network, and the second network node may comprise an AMF of the second network.

Systems, methods, and instrumentalities are disclosed for service provisioning and providing access to a PALS hosting network. A first message may be received from a wireless transmit/receive unit (WTRU). The first message may comprise a registration message. The registration message may indicate that the WTRU has detected a configuration failure event associated with a second network. The registration message may indicate an update request for a network configuration for a local service. The configuration information may be determined. The configuration information may be associated with the WTRU obtaining access to the second network. A second message may be sent to the WTRU. The second message may indicate at least one of a registration acceptance message or a configuration update message responsive to the update request. An updated control policy for the WTRU may be determined using the determined configuration information. A third message may be sent to the WTRU. The third message may comprise the updated control policy.

In an example, the updated control policy for the WTRU may be determined using the configuration information. A fourth message may be sent to the first network. The fourth message may comprise an indication to update a control policy for the WTRU based at least on the configuration information associated with the WTRU obtaining access to the second network. A fifth message may be received from the first network. The fifth message may comprise an indication that the control policy for the WTRU has been updated based at least on the configuration information associated with the WTRU obtaining access to the second network. The fifth message may comprise an updated control policy associated with the indication that the control policy of the WTRU has been updated.

In an example, the first network may comprise a policy control function (PCF) of the first network.

In an example, the configuration information associated with the WTRU obtaining access to the second network may be determined locally in the network node.

In an example, the configuration information associated with the WTRU obtaining access to the second network may be determined in a unified data management device (UDM).

In an example, the configuration information may include one or more of a data network name (DNN), a plurality of network slices deployed for the local service, a plurality of application target descriptors related to the local service, or a valid location and period of the local service.

In an example, the network node may comprise an access and mobility management function (AMF) of the first network. The second network may comprise an AMF of the second network.

Systems, methods, and instrumentalities are disclosed for networks providing access to localized services (PALS network). In examples, a WTRU may obtain a configuration and/or policy for PALS service/network from its home network. The WTRU may provide a PALS service and/or network information to the home network and may receive configuration and/or policy update(s) from the home network. In examples, the WTRU may obtain and store a list of temporary subscriber data for accessing a PALS hosting network. Temporary subscriber data may be associated with a PALS service, a valid location, and/or a time period.

In examples, a WTRU may receive, from a home network, configuration information associated with a network for providing access to localized services (PALS). The WTRU may send a message to the home network, the message indicating a request for updated information associated with the PALS network. The WTRU may receive update information from the home network based on the requested for updated information associated with the PALS network. The WTRU may send a registration message to the PALS network based on the updated information received from the home network. In examples, the WTRU may receive policy information for a PALS network. In examples, the WTRU may update the policy information based on the update information. If a visiting network has a business agreement with the PALS hosting network, the information may be provisioned including PALS service, network information, and/or policy for PALS service for visiting WTRU and a home network. The WTRU may receive configuration and/or policy update via the visiting network (VPLMN), for example, which may have a business agreement with the hosting network. A WTRU may receive and use hosting network provided local policies such as UE route selection policy (URSP).

Systems, methods, and instrumentalities are disclosed for networks providing access to localized services (PALS network). In examples, a WTRU may obtain a configuration and/or policy for PALS service/network from its home network. The WTRU may provide a PALS service and/or network information to the home network and may receive configuration and/or policy update(s) from the home network. In examples, the WTRU may obtain and store a list of temporary subscriber data for accessing a PALS hosting network. Temporary subscriber data may be associated with a PALS service, a valid location, and/or a time period.

In examples, a WTRU may receive, from a home network, configuration information associated with a network for providing access to localized services (PALS). The WTRU may send a message to the home network, the message indicating a request for updated information associated with the PALS network. The WTRU may receive update information from the home network based on the requested for updated information associated with the PALS network. The WTRU may send a registration message to the PALS network based on the updated information received from the home network. In examples, the WTRU may receive policy information for a PALS network. In examples, the WTRU may update the policy information based on the update information. If a visiting network has a business agreement with the PALS hosting network, the information may be provisioned including PALS service, network information, and/or policy for PALS service for visiting WTRU and a home network. The WTRU may receive configuration and/or policy update via the visiting network (VPLMN), for example, which may have a business agreement with the hosting network. A WTRU may receive and use hosting network provided local policies such as UE route selection policy (URSP).

FIG. 2 shows an example of a hosting network having access (e.g., direct access) to a home network. FIG. 3 shows an example of a hosting network having access (e.g., indirect access) to a home network.

A WTRU registered in the PALS hosting network may have discovered PALS service information. The PALS service information may include the hosting network identification, service identifiers, and/or the like. In examples, the WTRU may discover the information via hosting network system broadcasting or via non-access stratum (NAS) signaling (e.g., during a registration procedure or during a WTRU configuration update procedure). The WTRU may receive from the user input what the target and/or interested service is.

In examples, the WTRU may obtain a service configuration (e.g., proper service configuration) for one or more PALS service(s) from the home network. One or more of the following events may trigger the WTRU to turn to the home network for PALS service configuration: the WTRU may not receive configuration (e.g., proper configuration) from the hosting network (e.g., the WTRU may not receive an allowed NSSAI via the registration accept message from the hosting network), the WTRU may receive an indication from the hosting network that the configuration is not available or incomplete (e.g., the WTRU may receive such indication via the registration accept or reject message if the network cannot determine the configured NSSAI, allowed NSSAI, or other configurations for the WTRU), the network resource request may fail (e.g., the WTRU requested NSSAI may be rejected by the network during a registration procedure or the PDU session establishment request may be rejected due to configuration issue such as an unknown data network name (DNN), the WTRU may not find a matching URSP rule (e.g., any matching URSP rule except a “match all” rule) for the PALS service application, the user may manually trigger the WTRU to contact the home network for PALS service configuration, and/or the like.

In examples, if one or more of the events are triggered, the WTRU may initiate a registration update request to the home network, e.g., either directly or indirectly, for obtaining the service configuration for the PALS service(s). In the registration update request, the WTRU may include one or more of the information. The information may include an indication (e.g., explicit indication) that the registration is initiated for updating configuration for PALS services. The information may include the identification of the PALS hosting network. The information may include the target or interested PALS service identifiers. The information may include the WTRU identifier (e.g., a temporary identifier) used/registered with the PALS hosting network. In an example, if an indication (e.g., explicit information) is not present, the inclusion of information may indicate (e.g., implicitly indicate) the purpose of the request.

Based on receiving the registration update request for PALS service configuration, the serving access and mobility management function (AMF) in the home network may perform one or more of the following. Assuming the requested PALS service and hosting network information is stored in the AMF or another network function (e.g., policy control function (PCF), network slice selection function (NSSF), or operations, administration, and management (OAM), the AMF may retrieve the information and may work with other network function(s) such as NSSF to prepare the configured NSSAI for the PALS hosting network. Other slicing information may be prepared, such as the mapped S-NSSAIs of the home network. The configured NSSAI for the PALS hosting network may be associated with a validity period. The AMF may send the slicing configuration for the PALS hosting network to the WTRU via the registration accept message or may initiate a WTRU configuration update procedure to deliver the configuration. The serving AMF may invoke the PCF service (e.g., Npcf_WTRUPolicyControl service) to inform the PCF of the PALS service and hosting network information (e.g., target/interested service identifier, application descriptor(s), hosting network identification, configured NSSAI for the hosting network, DNNs for the PALS services, etc.). The PCF may update the WTRU policies (e.g., URSP rules) accordingly and may initiate the network-initiated WTRU policy management procedure to deliver the new WTRU policies to the WTRU. If the serving AMF is not able to handle PALS service configuration, it may forward the registration update request to another capable AMF.

In examples, if the WTRU receives the configured NSSAI for the PALS hosting network from the home network, the WTRU may initiate a registration procedure with the PALS hosting network and include one or more S-NSSAIs of the configured NSSAI as the requested NSSAI. The serving AMF in the hosting network may accept the requested NSSAI as allowed NSSAI, for example, if the network has the resources to support it. In examples, if the received configured NSSAI and other slicing configuration has a valid period, the WTRU may store (e.g., only stores) the configurations for the valid period and may discard them when the valid period is over. The URSP rules for matching PALS service-related application traffic may have an associated valid period. If the valid period is over, the WTRU may remove (e.g., automatically remove) the URSP rules.

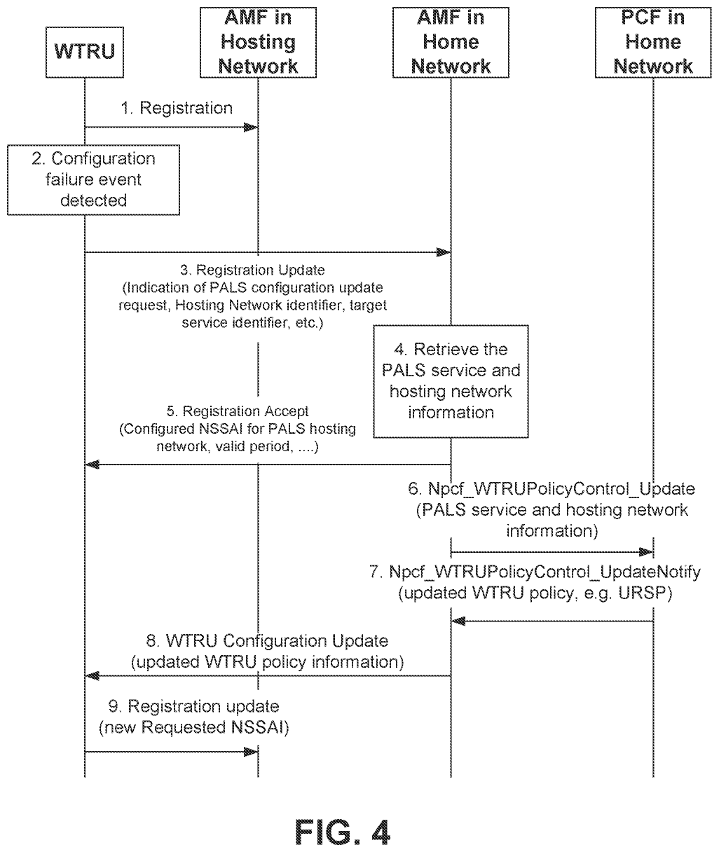

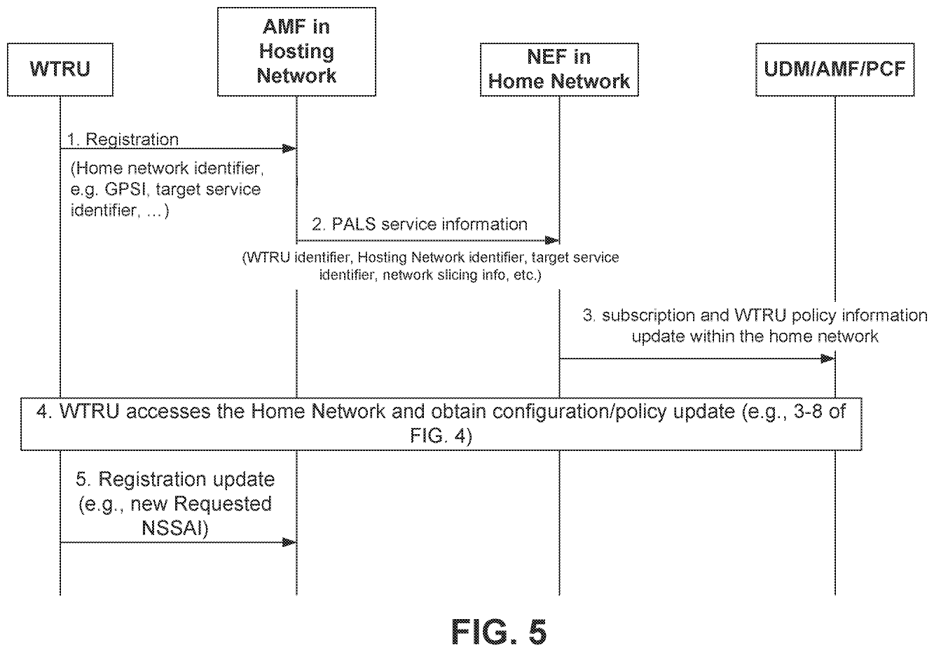

FIG. 4 shows an example PALS service configuration via a home network. At 1, the WTRU may discover the PALS hosting network and may register with the hosting network. At 2, the WTRU may send a message (e.g., a first message) to an AMF in the home network (e.g., a first network node) if a configuration failure event is detected. The AMF in the home network may be associated with a home network (e.g., a first network). The configuration failure event may be associated with an AMF in the hosting network (e.g., a second network), and the message may indicate an update request for a network configuration for a local service. The WTRU may detect a configuration related failure (e.g., a configuration failure). In examples, the configuration related failure may occur because the hosting network may reject the requested NSSAI, the requested NSSAI may not receive an allowed NSSAI (e.g., a proper allowed NSSAI), the requested NSSAI cannot match the application traffic using the URSP rules, and/or the requested NSSAI may receive an indication (e.g., explicit indication) from the hosting network that the WTRU configuration needs an update. In examples, the configuration related failure may occur if it is determined (e.g., by the WTRU) that the WTRU is unable to register with the AMF in the hosting network (e.g., a second network), if it is determined (e.g., by the WTRU) that the WTRU is missing the network configuration for the local service, and/or if it is determined (e.g., by the WTRU) that the network configuration includes an error. In examples, the configuration failure event may be associated with the WTRU connecting to the hosting network (e.g., an AMF in the hosting network) for use with the local service. For example, the configuration failure event may be associated with the WTRU being unable to connect to the hosting network for use with the local service.

At 3, the WTRU may initiate a registration update with its home network. The WTRU may access (e.g., directly access) the home network via an access, such as a 3GPP access or non-3GPP access, or it may access the home network via a hosting network. Using the registration update request, the WTRU may indicate that the registration is for configuration and policy update(s) for the PALS service and/or hosting network. The WTRU may provide information on the target PALS service and/or the hosting network.

At 4, the serving AMF in the home network may retrieve the information related to the PALS service and hosting network, such as the DNN and/or network slices deployed for the target service, application traffic descriptor(s) related to the target service, valid location and/or valid period for the target service, and/or the like. At 5, the serving AMF may construct the configured NSSAI for the PALS hosting network and send the configured NSSAI to the WTRU using a registration accept or WTRU configuration update message. A valid period may be associated with the configured NSSAI for the PALS hosting network. At 6, the AMF may invoke the Npcf_WTRUPolicyControl_Update service of the PCF and may provide the PALS service related information as the input. At 7, the PCF may update the related WTRU policy such as URSP based on the input and may return the updated policies to the AMF via Npcf_WTRUPolicyControl_UpdateNotify.

At 8, the AMF in the home network may deliver the updated policy information to the WTRU using the WTRU configuration update procedure. At 9, the WTRU may initiate a registration update with the PALS hosting network using the received configuration (e.g., received new configuration). In examples, the WTRU may construct the requested NSSAI using the configured NSSAI for the PALS hosting network received, as described herein.

In examples, the WTRU may inform the PALS hosting network of one or more of the following information when it accesses the hosting network, e.g., during the registration procedure: the WTRU identifier with the home network (e.g., the generic public subscription identifier (GPSI), mobile station integrated services digital network (MSISDN), etc.) or the user's interested/target service in the PALS hosting network.

The hosting network may identify the WTRU's hosting network and may send (e.g., push) the information related to the user's target service to the home network. The service information may include the hosting network identifier, service identifier, application traffic descriptor, network slices (e.g., s-NSSAIs) deployed for the service, valid location for the service, valid period for the service, and/or the like. The hosting network may invoke the NEF services provided by the home network to send (e.g., push) the information and identify the WTRU using the identifier received from the WTRU. The network functions in the home network, such as unified data management (UDM), PCF, and/or the like, may update the WTRU's subscription information and/or prepare the update of the related WTRU policies, such as URSP. The WTRU may access the home network and obtain the configuration and policy update for the PALS service from the home network.

FIG. 5 shows an example hosting network sending (e.g., pushing) PALS service information to the WTRU's home network. In examples, it may be possible that the WTRU's home network (e.g., home PLMN or subscribed SNPN) has not already obtained the PALS service information. The home network may be capable of retrieving the PALS service information via a third-party PALS service provider or via a repository (e.g., central repository) with which the home network has an association/agreement(s).

A WTRU may perform a radio scan to find out the available hosting networks at a current location and may share the information (e.g., list of available PALS hosting networks, along with PALS hosting network identifier and/or target PALS service identifier) with the home network via NAS signaling (e.g., registration or service request procedure). The radio scan, for example, may be performed based on a request from the user, based on a trigger to access the PALS network, and/or the like.

Based on a request from the WTRU via the NAS signaling to gather service information on the available PALS hosting network, a home network (e.g., AMF or network exposure function (NEF) may retrieve the information via an application interface (e.g., NEF or AF) through PALS service providers (e.g., identified via the hosting network identification (ID), or a unique identifier which may be broadcast by the hosting network and/or provided to the home network via WTRU NAS signaling) or through a central repository, e.g., which may be preconfigured in the home network). If service information is available (e.g., the PALS service information may include the identification of the hosting network for the PALS service, the identifiers of the PALS services provided in the hosting network, the network slices deployed in the hosting network for the PALS services, URSP rules such as traffic descriptor, matching policy, etc.), the AMF may relay the information to the WTRU via NAS signaling.

A WTRU may present the information to the user or may make a selection for the target hosting network. The WTRU may provide the acquired service information (e.g., slicing/URSP information) during or after the registration process.

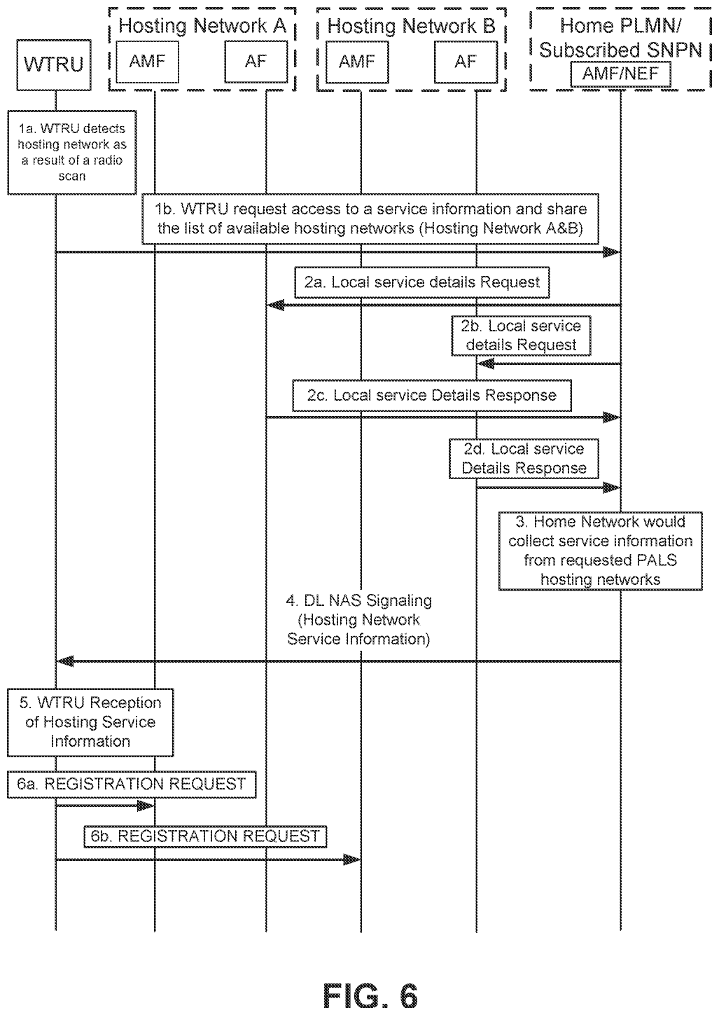

FIG. 6 shows an example of PALS service information retrieval (e.g., explicit PALS service information retrieval) from a home network. At 1a, WTRU may perform a radio scan and detect one or more available PALS hosting networks. At 1b, the WTRU may request access to the service information for the detected hosting networks. The list of hosting network, for example, along with the hosting network identifiers and target service information, may be shared with the home network via NAS signaling.

At 2a-2d, a number of processes may be performed. A home network (e.g., NEF) may retrieve service information from the hosting networks as presented by the WTRU (e.g., hosting networks A and B, as shown in FIG. 6). The information may be retrieved directly from the hosting network via the application interface or retrieved from a repository (e.g., central repository) with which home network may have an association/agreement(s) in place (e.g., or is configured in the home network). At 3, the home network (e.g., HPLMN or subscribed SNPN) may collect the service information from requested hosting networks (e.g., all requested hosting networks. At 4, the home network may share the service information on the hosting network with the WTRU via downlink NAS signaling. At 5, the WTRU may receive the service information on requested hosting networks and based on user trigger or other factors select a hosting network to get access to the local services. At 6a and/or 6b, the WTRU may select the hosting network and/or trigger registration with gathered information (e.g., configured NSSAI, slicing information, URSP rules, etc.)

In examples, the WTRU may inform the PALS hosting network of one or more of the following information when it accesses the hosting network, for example, during the registration procedure: the WTRU identifier with the home network (e.g., the GPSI, MSISDN, etc.) or the user's interested/target service in the PALS hosting network.

WTRU management of temporary SNPN subscriber data may be provided. If the PALS hosting network is a SNPN, the WTRU may obtain and/or store a list of temporary SNPN subscriber data for the PALS hosting networks and may treat the hosting network as a subscribed network. The WTRU may obtain the list of temporary subscriber data from its home network operator or other holder institutions.

In addition to the typical information included in the subscriber data, such as the WTRU identifier and credentials, network identifiers, default configured NSSAI, pre-configured URSP, and/or the like, the temporary subscriber data may be associated with one or more of the following information: service identifiers (e.g., if the temporary subscriber data contains this information, the WTRU may only select the hosting network if the network supports the service) or valid location and time period. For example, if the temporary subscriber data contains this information, the subscriber data may be only activated at the specified valid location and during the valid time period. If the valid time period is over and the subscriber data becomes obsolete, the WTRU may discard the temporary subscriber data. If the temporary subscriber data becomes activated, the WTRU may search for the hosting networks that match the subscriber data.

In examples, if a WTRU tries to search and select localized service and hosting networks, it may do it in manual mode or automatic mode. In manual mode, the user may manually trigger the WTRU to search for services/hosting network and may manually select the hosting network, while in automatic mode, the WTRU may automatically search and reselect the target hosting network.

In manual mode, if the localized service/hosting network configuration (e.g., temporary subscriber data) is available, the search and selection of the service/hosting network may use those present in the configuration. In examples, if the localized service/hosting network configuration (e.g., temporary subscriber data) is not available, the WTRU may search whatever is available and select the service/network that interests the user, e.g., based pm the local service information (e.g., service identifiers, human readable service information, etc.) broadcasted by the hosting network.

In automatic mode, the WTRU may (e.g., may only) search and select local service/hosting network when the localized service/hosting network configuration is available, and the search and selection may be limited to the services/hosting networks present in the configuration. The WTRU may automatically start the search based on one or more of the following conditions: the current time and/or location satisfies the service/hosting network validity condition in the configuration; or the WTRU has received network steering information (e.g., steering of roaming information) from the home or serving network, which indicates to the WTRU localized service/hosting network is available in the WTRU's area.

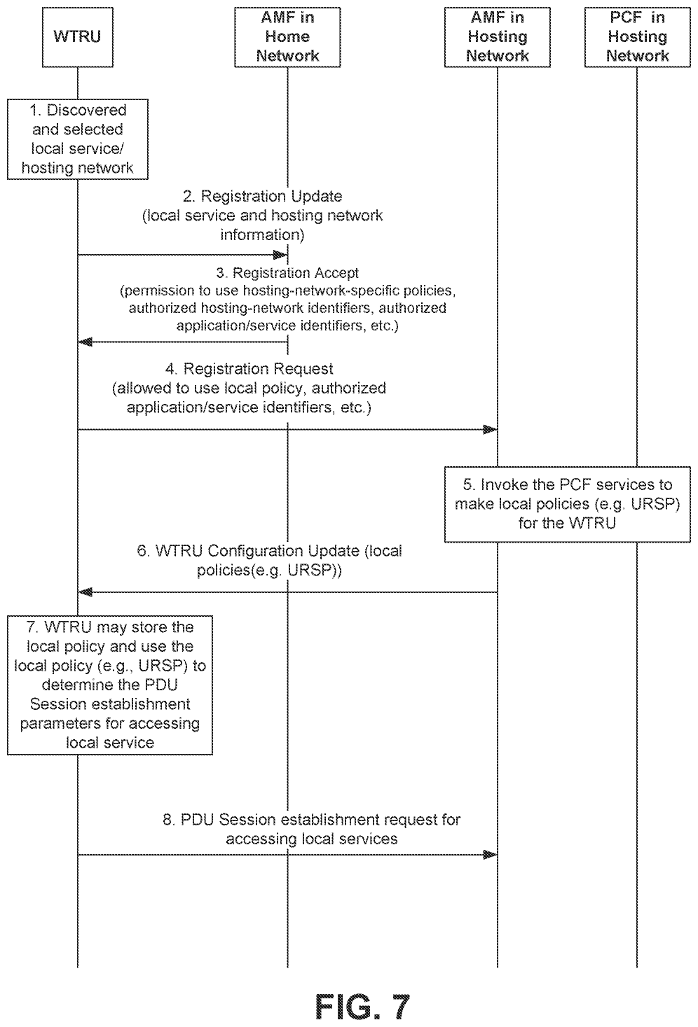

FIG. 7 shows an example of a WTRU receiving local policies from the hosting network. Hosting network or VPLMN provided URSP policy may be provided. A WTRU may receive hosting-network (e.g., or VPLMN)-specific policies directly from the hosting network or the VPLMN. These policies may include WTRU policies such as URSP, access network discovery and selection policy (ANDSP), Prose policy, etc. The WTRU may get (e.g., need to get) approval and/or authorization from its home network for receiving and/or using those policies provided by the hosting network or the VPLMN. The authorization may be made by the home network based on the WTRU subscription and home network policies. The hosting-network (or VPLMN)-specific policies may be (e.g., may only be) valid if the WTRU is registered in the hosting network or the VPLMN that provides the policies. The policies may have other constraints. For example, the policy provided by a local service hosting network may be valid for a period of time (e.g., only for a period of time such as a time corresponding to the local service available time period) and/or a service area.

The home network of the WTRU may determine whether the WTRU is (e.g., needs) allowed to receive and/or use the policies (e.g., URSP) from other networks and may provide its permission accordingly. For example, if the WTRU information in the home network indicates that the WTRU has subscribed to certain local services or 3^{rd} party services that are hosted by a hosting network (e.g., an SNPN or a VPLMN), and if the home network has service agreements with those hosting networks, the home network may indicate to the WTRU that it is allowed to receive and/or use certain policies directly provided by the hosting network, e.g., during a registration procedure. In examples, the home network may determine that the WTRU is within the service area of certain local service and may indicate to the WTRU that it is allowed to receive and/or use some hosting-network-specific policies.

The WTRU may explicitly request for the permission to receive and/or use hosting-network-specific policies (e.g., some hosting-network-specific policies). For example, if the user has discovered certain local services and is interested in accessing the service, it may trigger the WTRU to request the information (e.g., necessary information) from its home network for accessing the service and its hosting network, including the permission to use the policies directly provided by the hosting network. If authorized, the home network may provide the permission to the WTRU.

The permission from the home network may include one or more of the following information: the network identifiers of the hosting network or VPLMN that are authorized for WTRU to receive policies from, for example, the S-NPN identifiers or VPLMN IDs; the type of the policies (e.g., URSP) that are authorized for the WTRU to receive and/or use in the hosting network; the service and/or application identifiers that are authorized to apply the hosting-network-specific policies; a time period during which the hosting-network-specific policies may be valid; a service area within which the hosting-network-specific policies may be valid; authorization to receive policies from hosting-networks/VPLMNs; or whether the hosting-network-specific policies may have higher priority when the WTRU is registered with the hosting network.

The configuration information on reception of local policies from hosting-networks/VPLMNs may be (pre) configured e.g., store in mobile equipment (ME) or universal subscriber identity module (USIM). The home network may use the SIM refresh to dynamically update the configured information on the USIM/ME.

When the WTRU accesses a hosting network or a VPLMN, e.g., registering with the network, and if the hosting network identifier is authorized by the home network (e.g., or as per the information configured in the ME/USIM) that the WTRU may use the local policies in this network, the WTRU may indicate to the hosting network or VPLMN that it is allowed to use the local policies in the network. The WTRU may indicate the type of policies (e.g., URSP) and the authorized application and/or service identifiers that local policies may apply. Accordingly, the hosting network may make local policies (e.g., URSP) and deliver them to the WTRU. The hosting network may assign its own constraints associated with the local policies, such as a time period and/or a service area for the local policies to be valid. The hosting network provided policies may (e.g., may only) include the information for the WTRU's authorized services/applications.

The WTRU may store the received local policies and associate them with the network identifier that provided the policies. The WTRU may have policies from both the home network and the hosting network. For example, the WTRU may have a set of URSP rules configured by the home network and at the same time may receive a set of URSP rules provided by the hosting network. The policies from different sources may be stored separately and there may be priorities among policies from different sources. For example, the home network provided URSP rules may have higher priority than hosting network provided URSP rules. For example, if the WTRU is registered in the hosting network and provided with local hosting-network-specific policies, it may consider the local policies higher priority.

If the WTRU uses (e.g., needs to use) certain policies to determine its actions, for example, when the WTRU applies (e.g., needs to apply) URSP rules to determine how to establish a PDU Session for accessing a local service, it may check the higher priority URSP rules (e.g., either home-network-provided URSP rules or local URSP rules) first. If the service and/or application identifier is not among the high priority URSP rules, the WTRU may check the lower priority URSP rules. For example, if there is no matching of a local service identifier in the home-network URSP rules and there is a matching in the local hosting-network URSP rules, the WTRU may apply the URSP rule in the hosting-network URSP to determine the parameters for accessing the service.

In examples, if the WTRU leaves the hosting network, e.g., deregisters with the network, the WTRU may discard local policies previously received from the network.

A WTRU and/or home network may be provisioned with information to access local service (PALS) in a visiting network (VPLMN), for example, which may have a business agreement with the hosting network.

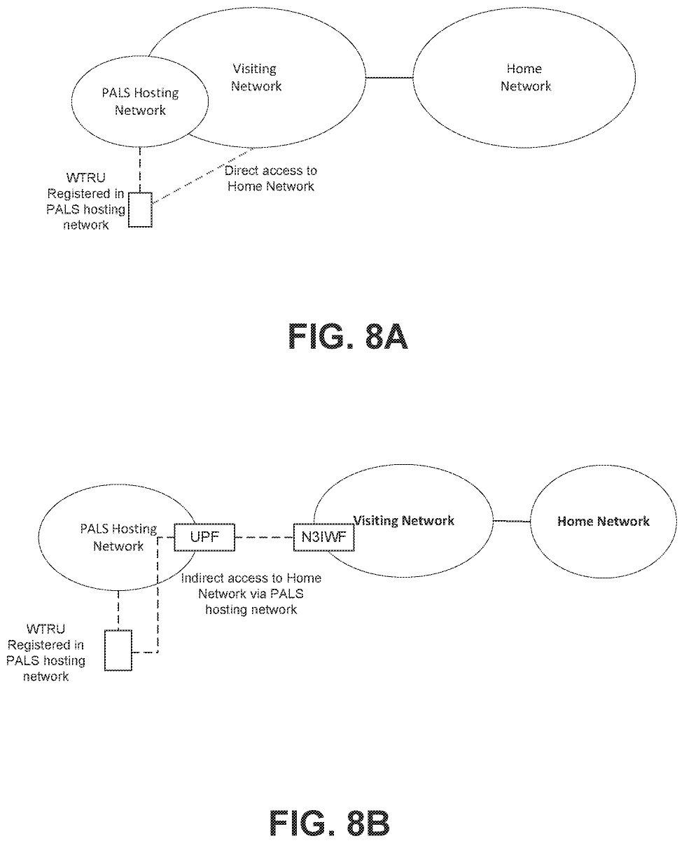

PALS service configuration via the roaming network may be provided. In examples, a PLMN (e.g., a VPLMN) may have obtained the PALS service information and may have a business agreement with the PALS hosting network. The WTRU's HPLMN may have a roaming agreement with the VPLMN and may authorize the visiting network to update PALS-related configuration(s) in the UDM in HPLMN. The PALS service information may include the identification of the hosting network for the PALS service, the temporary identifiers and credential of the PALS services provided in the hosting network, the network slices deployed in the hosting network for the PALS services, the application identifier and/or descriptor that may be used to access PALS services, and/or the like. The visiting network may obtain the service information via cooperation process with the PALS service providers. A WTRU registered in the PALS hosting network may access the visiting network, e.g., either directly if it is in the coverage of the visiting network as shown with respect to FIG. 8A or indirectly via the PALS hosting network and the N3IWF in the visiting network, as shown with respect to FIG. 8B. FIG. 8A shows an example of providing access (e.g., direct access) to a network, such as a mobile network (PLMN) network. FIG. 8B shows an example of providing access (e.g., indirect access) to a network, such as a PLM network.

PALS service configuration may be provided. In examples, if one or more of the events trigger the WTRU to request the configuration of the PALS from the VPLMN that has a business agreement with the hosting network, the WTRTU may initiate a registration update request to the visiting network, e.g., either directly or indirectly, for obtaining the service configuration for the PALS services.

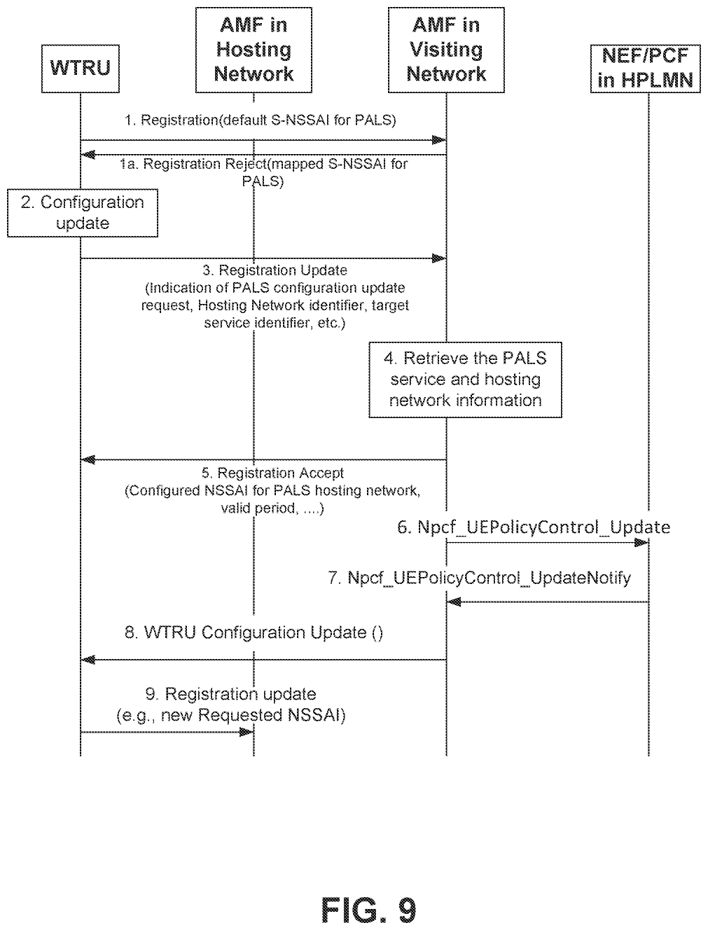

FIG. 9 shows an example of configuring the roaming WTRU with PALS service. At 1, the WTRU may send a registration request with the S-NSSAI_{PALS} service or with a NSSAI_{LOCAL} associated with the PALS in the hosting network (e.g., via an advertisement, system broadcast, and/or the like). In examples, if the WTRU accesses the VPLMN with S-NSSAI_{LOCAL}, the WTRU may directly initiate a registration update with the VPLMN as described herein, such as at 3. At 1b, the AMF in the VPLMN may map the NSSAI_{LOCAL} of PALS to the S-NSSAI_{PALS} and may send it back to the WTRU with a registration rejection. At 2, the WTRU may update the slice configuration, for example, when it receives an indication (e.g., explicit indication) from the hosting network that the WTRU configuration is to be updated. At 3, the WTRU may initiate a registration update with the VPLMN. The WTRU may indicate that the registration is for configuration and/or policy update for the PALS service and/or hosting network in the registration update request. The WTRU may provide information on the target PALS service and/or the hosting network. In the registration update request, the WTRU may include one or more of the following information: an indication (e.g., explicit indication) that the registration is initiated for updating configuration for PALS services (e.g., if an explicit indication is not present, the inclusion of one or more other information described herein may implicitly indicate the purpose of the request); the identification of the PALS hosting network; the target; and/or interested PALS service identifiers.

At 4, the serving AMF in the home network may retrieve the information related to the PALS service and hosting network, such as the DNN and network slices deployed for the target service, application traffic descriptor(s) related to the target service, valid location and/or period for the target service, and/or the like. At 5, the serving AMF may construct the configured NSSAI for the PALS hosting network and send it to the WTRU, for example, using a registration accept or a WTRU configuration update message. A valid period may be associated with the configured NSSAI for the PALS hosting network. At 6, the AMF may send the Npof_UEPolicyControl_Update to the PCF of the WTRU home network and may provide the PALS service-related information as the input. At 7, the home PCF may update the related WTRU policy, such as URSP, based on the input and may return one or more updated policies to the AMF in Npof_UEPolicyControl_UpdateNotify. At 8, the AMF may deliver the updated policy information to the WTRU, for example, using the WTRU configuration update procedure. At 9, the The WTRU may initiate a registration update with the PALS hosting network using the received new configuration. For example, the WTRU may construct the requested NSSAI using the configured NSSAI for the PALS hosting network received as described with respect to the serving AMF constructing the configured NSSAI for the PALS hosting network and sending it to the WTRU using a registration accept or WTRU configuration update message, such as, for example a message received at 5.

PALS access ID and/or credential provision may be used.

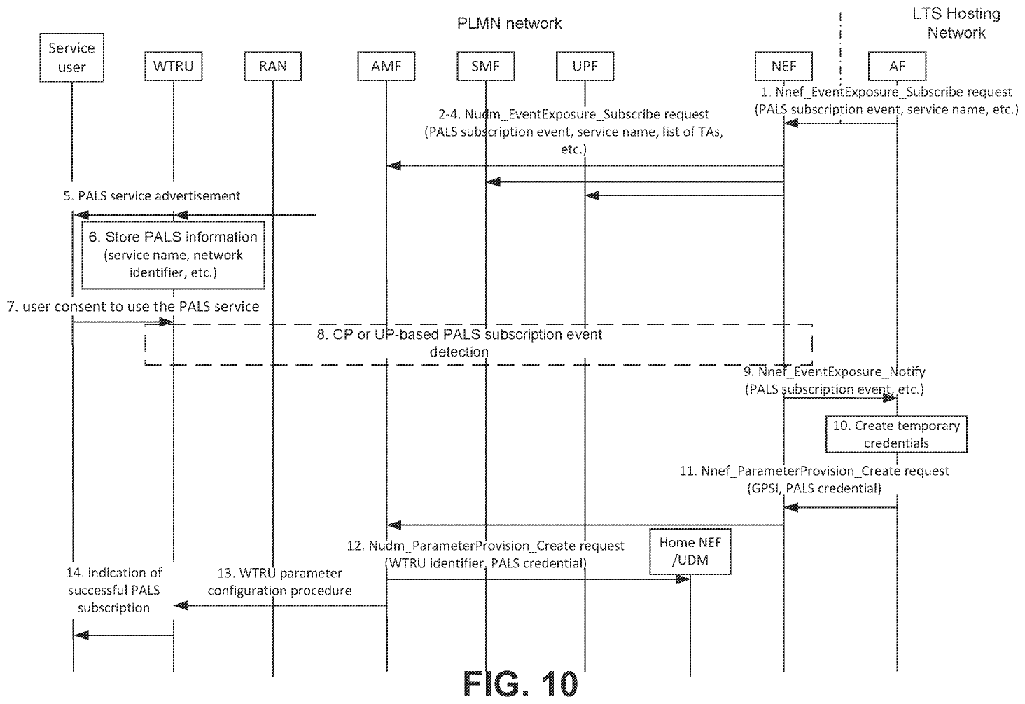

FIG. 10 shows an example of provisioning the roaming WTRU with PALS access ID and credentials. The AF in the hosting network may subscribe to the LTS subscription request event notification in the PLMN by sending an Nnef_EventExposure_Subscribe request to the NEF. The AF may provide event-related information such as the LTS service name, hosting network identifier, LTS service area, and/or the like in the request.

At 2-4, the NEF may send one or more subscription requests. The NEF may subscribe to the event notification by sending Nudm_EventExposure_Subscribe request to the AMF, SMF, and/or UPF. At 5, the potential service user and/or WTRU may receive LTS service advertisement. At 6, the LTS service information, such as LTS service name, hosting network identifier, etc., may be stored in the WTRU. At 7, the user may consent to use the service. The user consent may trigger the WTRU to initiate a LTS subscription request in the PLMN using a CP-based technique as described herein or an UP-based technique as described herein.

At 8, a CP or UP-based PALS subscription event may be detected. A CP-based technique or UP-based technique may trigger a WTRU NAS service request message to the serving AMF or an HTTP request towards a URL which may have been provided in the service advertisement. The HTTP request may be sent over the PDU session in the PLMN.

In an example, with a CP-based method, the UE may send a NAS Service Request message to the serving AMF. The Service Request message may include a LTS subscription request indication and a LTS information container. If the LTS information (service name, network identifier) in the Service Request message matches the event monitoring configuration the AMF received, the AMF may considers the LTS subscription event has been detected and may notify the NEF of the event by sending a Namf_EventExposure_Notify to the NEF.

In an example, with UP-based method, the UE may send a HTTP Request towards a URL which was provided in the service advertisement. The HTTP request may be sent over the PDU Session in the PLMN. If the IP header information of a packet matches what may be configured, the UPF may report it to the SMF. The UPF may retrieve other information in the HTTP request by packet inspection (e.g., deep packet inspection) and may send it to the SMF. The SMF may notify the NEF of the event by sending a Nsmf_EventExposure_Notify to the NEF.

At 9, the NEF may forward the event notification from AMF or SMF to the AF in the hosting network. The NEF may augment the event notification with information such as the GPSI of the WTRU, home PLMN and serving PLMN identifier, and/or the like. At 10, the AF (e.g., with the provisioning server in the hosting network) may allocate a temporary WTRU identifier and credentials for the WTRU. At 11, the AF may invoke the NEF service to deliver the credentials and the associated network identifier to the WTRU by sending a Nnef_ParameterProvision_Create request to the NEF.

At 12, the NEF may send Nnef_ParameterProvision_Create request to the AMF in the service network. The AMF may act as an external AF to request the UDM in the WTRU HPLMN to store the LTS credential and/or other related parameters as part of WTRU subscriber data by sending a Nudm_ParameterProvision_Create request to the UDM. At 13, the AMF may deliver the PALS credential and/or other related parameters to the WTRU. The WTRU may store the data and may start a timer to monitor the validity of the data according to the lifetime period associated with the data. At 14, based on receiving the LTS credential and/or configuration, the WTRU may indicate to the user that the PALS service subscription is successful. In examples, if the WTRU determines that the received PALS credential has expired (e.g., based on the lifetime associated with the credential) the WTRU may locally discard the credential. The UDM in the PLMN may discard the LCS credential and other related parameters if it has expired or based on the request of the AF of the LCS hosting network.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may apply to other wireless systems. For example, although the solutions described herein consider LTE, LTE-A, New Radio (NR) or 5G specific protocols, it is understood that the solutions described herein are not restricted to this scenario and apply to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-30. (canceled)

31. A wireless transmit/receive unit (WTRU), the WTRU comprising:
a processor that is configured to:
send a first message to a first network node based on a configuration failure event, wherein the first network node is associated with a first network, wherein the configuration failure event is associated with a second network, and wherein the first message indicates an update request for a network configuration for a local service of the second network;
receive a second message from the first network node, wherein the second message indicates a response to the update request, indicates an updated network configuration for the local service of the second network, and indicates one or more slice identifiers associated with the second network;
receive a third message from the first network node, wherein the third message indicates policy information associated with the local service of the second network; and
send a fourth message to a second network node, wherein the second network node is associated with the second network, wherein the fourth message is based on the policy information and the updated network configuration for the local service of the second network, and wherein the fourth message indicates a registration request associated with the one or more slice identifiers.

32. The WTRU of claim 31, wherein the processor is further configured to determine the configuration failure event, and wherein the configuration failure event is associated with the WTRU connecting to the second network node for use with the local service.

33. The WTRU of claim 31, wherein the configuration failure event indicates at least one of a requested slice identifier was rejected by the second network node, a configuration is missing a slice identifier, a routing rule is missing, the second network node requested a configuration update, a configuration for the local service is missing, or a configuration includes an error.

34. The WTRU of claim 31, wherein the processor is further configured to determine a registration failure event, wherein the first message is sent to the first network node based on the configuration failure event and the registration failure event, and wherein the registration failure event indicates that the WTRU is unable to register with the second network.

35. The WTRU of claim 31, wherein the processor is further configured to determine a local service failure event, wherein the first message is sent to the first network node based on the configuration failure event and the local service failure event, and wherein the local service failure event indicates that the WTRU is unable to use the local service.

36. The WTRU of claim 31, wherein the first message further indicates a request for at least one of the updated network configuration, a slice identifier associated with the second network, or the policy information.

37. A network node associated with a first network, the network node comprising:
a processor configured to:
receive a first message from a wireless transmit/receive unit (WTRU), wherein the first message indicates a configuration failure event associated with a second network and indicates an update request for a network configuration for a local service of the second network;
determine updated network configuration for the local service of the second network;
send a second message to the WTRU, wherein the second message indicates a response to the update request, indicates the updated network configuration for the local service of the second network, and indicates one or more slice identifiers associated with the second network;
determine a policy information based on the updated network configuration, wherein the policy information is associated with the local service of the second network; and
send a third message to the WTRU, wherein the third message indicates the policy information.

38. The network node of claim 37, wherein the network node is a first network node, and wherein the processor being configured to determine the policy information based on the updated network configuration comprises the processor being configured to:
determine a second network node using the updated network configuration, wherein the second network node is associated with the second network;
send a fourth message to the second network node, wherein the fourth message indicates a request for service information associated with the local service and the WTRU;
receiving a fifth message from the second network, wherein the fifth message indicates the service information; and
determine the policy information using the service information.

39. The network node of claim 37, wherein the first message further indicates a request for at least one of the updated network configuration, a slice identifier associated with the second network, or the policy information.

40. The network node of claim 37, wherein the configuration failure event indicates at least one of a requested slice identifier was rejected by a second network node, a configuration is missing a slice identifier, a routing rule is missing, the second network node requested a configuration update, a configuration for the local service is missing, or a configuration includes an error.

41. The network node of claim 37, wherein the first message further indicates a registration failure event, and wherein the registration failure event indicates that the WTRU is unable to register with the second network.

42. The network node of claim 37, wherein the first message further indicates a local service failure event, and wherein the local service failure event indicates that the WTRU is unable to use the local service.

43. The network node of claim 37, wherein the updated network configuration comprises at least one of a data network name (DNN), a plurality of network slices deployed for the local service, a plurality of application target descriptors related to the local service, or a valid location and period of the local service.

44. A method for determining a configuration for a service, the method comprising:
sending a first message to a first network node based on a configuration failure event, wherein the first network node is associated with a first network, wherein the configuration failure event is associated with a second network, and wherein the first message indicates an update request for a network configuration for a local service of the second network;
receiving a second message from the first network node, wherein the second message indicates a response to the update request, indicates an updated network configuration for the local service of the second network, and indicates one or more slice identifiers associated with the second network;
receiving a third message from the first network node, wherein the third message indicates policy information associated with the local service of the second network; and
sending a fourth message to a second network node, wherein the second network node is associated with the second network, wherein the fourth message is based on the policy information and the updated network configuration for the local service of the second network, and wherein the fourth message indicates a registration request associated with the one or more slice identifiers.

45. The method of claim 44, wherein the method further comprises determining the configuration failure event, and wherein the configuration failure event is associated with a wireless transmit/receive (WTRU) connecting to the second network node for use with the local service.

46. The method of claim 44, wherein the configuration failure event indicates at least one of a requested slice identifier was rejected by the second network node, a configuration is missing a slice identifier, a routing rule is missing, the second network node requested a configuration update, a configuration for the local service is missing, or a configuration includes an error.

47. The method of claim 44, wherein the method comprises further comprises determining a registration failure event, wherein the first message is sent to the first network node based on the configuration failure event and the registration failure event, and wherein the registration failure event indicates that a wireless transmit/receive (WTRU) is unable to register with the second network.

48. The method of claim 44, wherein the method further comprises determining a local service failure event, wherein the first message is sent to the first network node based on the configuration failure event and the local service failure event, and wherein the local service failure event indicates that a wireless transmit/receive (WTRU) is unable to use the local service.

49. The method of claim 44, wherein the first message further indicates a request for at least one of the updated network configuration, a slice identifier associated with the second network, or the policy information.
